(19) United States
(12) Patent Application Publication
(10) Pub. No.: US 2026/0220951 A1
(43) Pub. Date: Jul. 30, 2026

(54) MULTI-LEVEL IMAGE CLASSIFIER FOR BLOOD CELL IMAGES

(71) Applicant: BECKMAN COULTER, INC., Brea, CA (US)

(72) Inventors: Jiuliu LU, Miami, FL (US); Bian QIAN, Fort Lauderdale, FL (US); Bart WANDERS, Trabuco Canyon, CA (US); Carlos A. RAMIREZ, Miami, FL (US)

(21) Appl. No.: 19/142,116

(22) PCT Filed: Dec. 22, 2023
(86) PCT No.: PCT/US2023/085666

§ 371 Date: Jun. 20, 2025

Related U.S. Application Data
(60) Provisional application No. 63/434,798, filed on Dec. 22, 2022.

(51) Int. Cl. G06V 20/69; G06V 10/764; G06V 10/776; G06V 10/82; G06V 20/70

(52) U.S. Cl. CPC G06V 20/698; G06V 10/764; G06V 10/776; G06V 10/82; G06V 20/693; G06V 20/70; G06V 2201/03

(57) ABSTRACT

Disclosed herein are various embodiments related to a blood cell classification system, which may include a plurality of general classifiers and specialized classifiers. The system being configured to determine, using the plurality of general classifiers, a predicted cell label for an imaged blood cell. The plurality of predicted cell labels are then provided to a decision aggregator which determines whether the predicted cell labels fulfil one or more compatibility criteria. Responsive to determining that the predicted cell label fulfils the one or more compatibility criteria the decision aggregator assigns the consolidated cell label based on one or more of the predicted cell labels provided by the plurality of classifiers Alternatively, responsive to determining that the predicted cell label does not fulfill the one or more compatibility criteria the decision aggregator provides the cell labels to a specialized classifier configured to assign the consolidated cell label.

### CROSS REFERENCE TO RELATED APPLICATIONS

This claims priority from, and is a nonprovisional of, provisional patent application 63/434,798, entitled “Multi-Level Image Classifier for Blood Cell Images” and filed in the U.S. patent and trademark office Dec. 22, 2022. That application is hereby incorporated by reference in its entirety.

### BACKGROUND

Blood cell analysis is one of the most commonly performed medical tests for providing an overview of a patient's health status. A blood sample can be drawn from a patient's body and stored in a test tube containing an anticoagulant to prevent clotting. A whole blood sample normally comprises three major classes of blood cells including red blood cells (erythrocytes), white blood cells (leukocytes) and platelets (thrombocytes). Each class can be further divided into subclasses of members. For example, five major types or subclasses of white blood cells (WBCs) have different shapes and functions. White blood cells may include neutrophils, lymphocytes, monocytes, eosinophils, and basophils. There are also subclasses of the red blood cell types. The appearances of particles in a sample may differ according to pathological conditions, cell maturity and other causes. Red blood cell subclasses may include reticulocytes and nucleated red blood cells. As a result, classification of different cell types and subtypes can be challenging, and there is a need for improved technology for this purpose.

### SUMMARY

Embodiments of the present disclosure may use a plurality of classifiers to classify one or more blood cells in a sample.

One embodiment may be to provide a computer-implemented cell classification system, having a processor and a non-transitory computer readable medium storing instructions that cause the processor to perform a set of acts. Those acts may include determining, using a plurality of classifiers, a predicted cell label of a cell, wherein each of the plurality of classifiers provide a predicted cell label of a cell; and providing the predicted cell label to a decision aggregator configured to assign a consolidated cell label.

In a further embodiment, a computer-implemented method of classifying a cell may exist in which an image of a cell is obtained. The method may then identify, using a plurality of classifiers and the image of the cell, a plurality of predicted cell labels of the cell, wherein each predicted cell label of the plurality of predicted cell labels is obtained by using a respective classifier of the plurality of classifiers. The method may further assign a consolidated cell label to the cell by using a decision aggregator and one or more of the predicted cell labels of the plurality of predicted cell labels.

In another embodiment, a computer-implemented training method of classifying a cell may exist in which an image of a cell is received. The method may then provide the image of the cell to a plurality of classifiers, training each of the plurality of classifiers to provide a predicted cell label based on the image of the cell. The method may further train a decision aggregator to identify a consolidated cell label of the cell based on the predicted cell label.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 is a schematic illustration, partly in section and not to scale, showing operational aspects of an exemplary flowcell, autofocus system and high optical resolution imaging device for sample image analysis using digital image processing.

FIG. 2 illustrates a slide-based vision inspection system in accordance with an embodiment.

FIG. 3 illustrates an example classification system having a plurality of general classifiers and a specialized classifier in accordance with an embodiment.

FIG. 4 illustrates a flowchart showing a method which could be used in an architecture associated with an embodiment.

The drawings are not intended to be limiting in any way, and it is contemplated that various embodiments of the invention may be can-ied out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The present disclosure relates to apparatus, systems, and methods for analyzing a blood sample containing blood cells. In one embodiment, the disclosed technology may be used in the context of an automated imaging system which comprises an analyzer which may be, for example, a visual analyzer. In some embodiments, the visual analyzer may further comprise a processor to facilitate automated conversion and/or analysis of the images.

According to some aspects of this disclosure, a system comprising a visual analyzer may be provided for obtaining images of a sample comprising particles (e.g., blood cells) suspended in a liquid. Such a system may be useful, for example, in characterizing particles in biological fluids, such as detecting and quantifying erythrocytes, reticulocytes, nucleated red blood cells, platelets, and white blood cells, including white blood cell differential counting, categorization and subcategorization and analysis. Other similar uses such as characterizing blood cells from other fluids are also contemplated.

The classification of blood cells in a blood sample is an exemplary application for which the subject matter is particularly well suited, though other types of body fluid samples may be used. For example, aspects of the disclosed technology may be used in analysis of a non~biood body fluid sample comprising blood cells (e.g., white blood cells and/or red blood cells), such as serum. bone marrow, lavage fluid, effusions, ex.udates, cerebrospinal fluid, pleural fluid, perineal fluid, and amniotic fluid. It is also possible that the sample can be a solid tissue sample, e.g., a biopsy sample that has been treated to produce a cell suspension. Th, [symbol] sample may also be a suspension obtained from treating a fecal sample. A-; ample may also be a laboratory or production line sample comprising panides, such as a cell culture sample, The tern1:-. ample may be u:-.ed to refer to a sample obtained from a patient or laboratory or any fraction, portion or aliquot thereoL The sample can be diluted, divided into portions, or stained in some processes. Additionally, the techniques contemplated herein can be used on various biological-.; ell types to enable proper classification of cells, though the embodiments presented herein are primarily discussed related to blood cells, they can also be used on other cell types and with other types of samples, —; such as with urine samples or other biological particles
as such the techniques romernplawd herein are geared towards proper classification of biological material.

In some aspects, samples are presented, imaged and analyzed in an automated manner. In the case of blood samples, the sample may be substantially diluted with a suitable diluent or saline solution, which reduces the extent to which the view of some cells might be hidden by other cells in an undiluted or less-diluted sample. The cells can be treated with agents that enhance the contrast of some cell aspects, for example using permeabilizing agents to render cell membranes pelmeable, and histological stains to adhere in and to reveal features, such as granules and the nucleus. In some cases, it may be desirable to stain an aliquot of the sample for counting and characterizing particles which include reticulocytes, nucleated red blood cells, and platelets, and for white blood cell differential, characterization and analysis. In other cases, samples containing red blood cells may be diluted before introduction to the flow cell and/or imaging in the flow cell or otherwise.

The particulars of sample preparation apparatus and methods for sample dilution, permeabilizing and histological staining, generally may be accomplished using precision pumps and valves operated by one or more programmable controllers. Examples can be found in patents such as U.S. Pat. No. 7,319,907. Likewise, techniques for distinguishing among certain cell categories and/or subcategories by their attributes such as relative size and color can be found in U.S. Pat. No. 5,436,978 in connection with white blood cells. The disclosures of these patents are hereby incorporated by reference in their entirety.

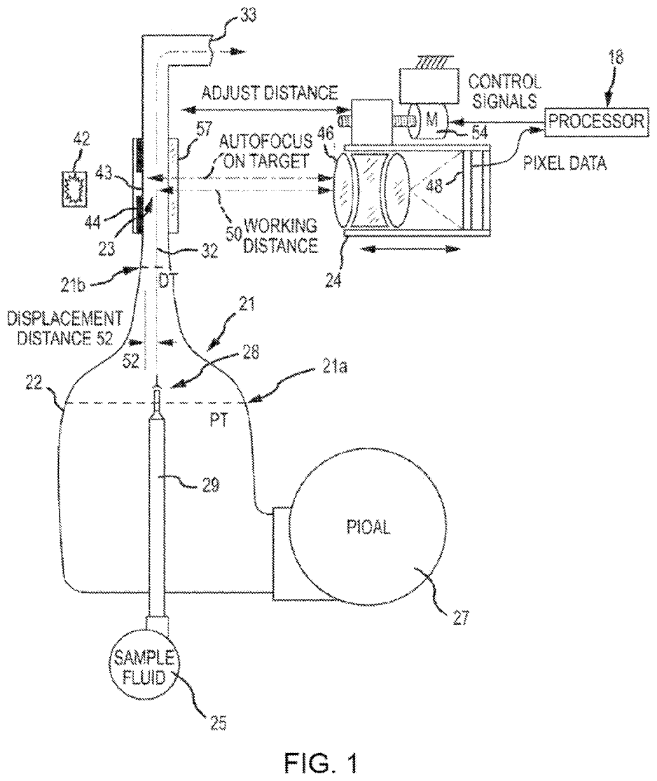

Turning now to the drawings, FIG. 1 schematically shows an exemplary flowcell 22 for conveying a sample 1luid through a viewing zone 23 of a high optical resolution imaging device 24 in a configuration for imaging microscopic particles in a sample flow stream 32 using digital image processing. Flowcell 22 is coupled to a source 25 of sample fluid which may have been subjected to processing, such as contact with a particle contrast agent composition and heating. Flowcell 22 is also coupled to one or more sources 27 of a particle and/or intracellular organelle alignment liquid (PIOAL), such as a clear glycerol solution having a viscosity that is greater than the viscosity of the sample fluid, an example of which is disclosed in U.S. Pat. Nos. 9,316,635 and 10,451,612, the disclosures of which are hereby incorporated by reference in their entirety.

The sample fluid is injected through a flattened opening at a distal end 28 of a sample feed tube 29, and into the interior of the flowcell 22 at a point where the PIOAL flow has been substantially established resulting in a stable and symmetric laminar flow of the PTOAL above and below (or on opposing sides of) the dbbon-shaped sample stream. The sample and PIOAL streams may be supplied by precision metedng pumps that move the PIOAL with the injected sample fluid along a flowpath that narrows substantially. The PIOAL envelopes and compresses the sample fluid in the zone 21 where the flowpath narrows. Hence, the decrease in flowpath thickness at zone 21 can contribute to a geometric focusing of the sample flow stream 32. The sample flow stream 32 is enveloped and carded along with the PIOAL downstream of the narrowing zone 21, passing in front of, or otherwise through the viewing zone 23 of, the high optical resolution imaging device 24 where images are collected, for example, using a CCD 48. Processor 18 can receive, as input, pixel data from CCD 48. The sample fluid dbbon flows together with the PIOAL to a discharge 33.

As shown here, the narrowing zone 21 can have a proximal flowpath portion 21a having a proximal thickness PT and a distal flowpath portion 21b having a distal thickness DT, such that distal thickness DT is less than proximal thickness PT. The sample fluid can therefore be injected through the distal end 28 of sample tube 29 at a location that is distal to the proximal portion 21a and proximal to the distal portion 21b. Hence, the sample fluid can enter the PIOAL envelope as the PIOAL stream is compressed by the zone 21, wherein the sample fluid injection tube has a distal exit port through which sample fluid is injected into flowing sheath fluid, the distal exit port bounded by the decrease in flowpath size of the flowcell.

The digital high optical resolution imaging device 24 with objective lens 46 is directed along an optical axis that intersects the ribbon-shaped sample flow stream 32. The relative distance between the objective 46 and the flowcell 22 is variable by operation of a motor drive 54, for resolving and collecting a focused digitized image on a photosensor array. Additional information regarding the construction and operation of an exemplary flowcell such as shown in FIG. 1 is provided in U.S. Pat. No. 9,322,752, entitled “Flowcell Systems and Methods for Pailicle Analysis in Blood Samples,” filed on Mar. 17, 2014, the disclosure of which is hereby incorporated by reference in its entirety.

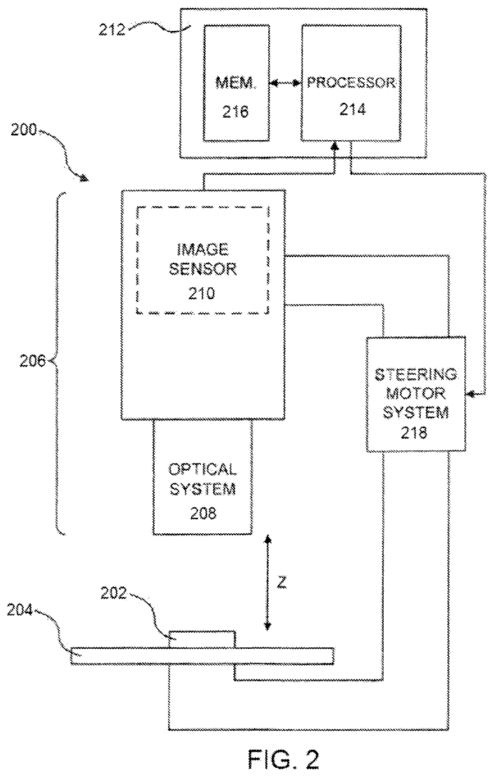

Aspects of the disclosed technology may also be applied in contexts other than flowcell systems such as shown in FIG. 1. For example, FIG. 2 illustrates a slide-based vision inspection system 200 in which aspects of the disclosed technology may be used. In the system shown in FIG. 2, a slide 202 comprising a sample, such as a blood sample, is placed in a slide holder 204. The slide holder 204 may be adapted to hold a number of slides or only one, as illustrated in FIG. 2. An image capturing device 206, comprising an optical system 208 and an image sensor 210, is adapted to capture image data depicting the sample in the slide 202. Further, in order to control the light environment and hence get image data, which is easier to analyze, a light emitting device (not shown) may be used.

The image data captured by the image capturing device 206 can be transferred to an image processing device 212. The image processing device 212 may be an external apparatus, such as a personal computer, connected to the image capturing device 206. Alternatively, the image processing device 212 may be incorporated in the image capturing device 206. The image processing device 212 can comprise a processor 214, associated with a memory 216, configured to determine changes needed to determine differences between the actual focus and a correct focus for the image capturing device 206. When the difference is determined an instruction can be transferred to a steering motor system 218. The steering motor system 218 can, based upon the instruction from the image processing device 212, alter the distance z between the slide 202 and the optical system 208. Descriptions of approaches which may be used for focusing using this type of setup are provided in U.S. Pat. Nos. 9,857,361, 10794900, 10705008, 10705011, the disclosures of which are hereby incorporated by reference in their entirety.

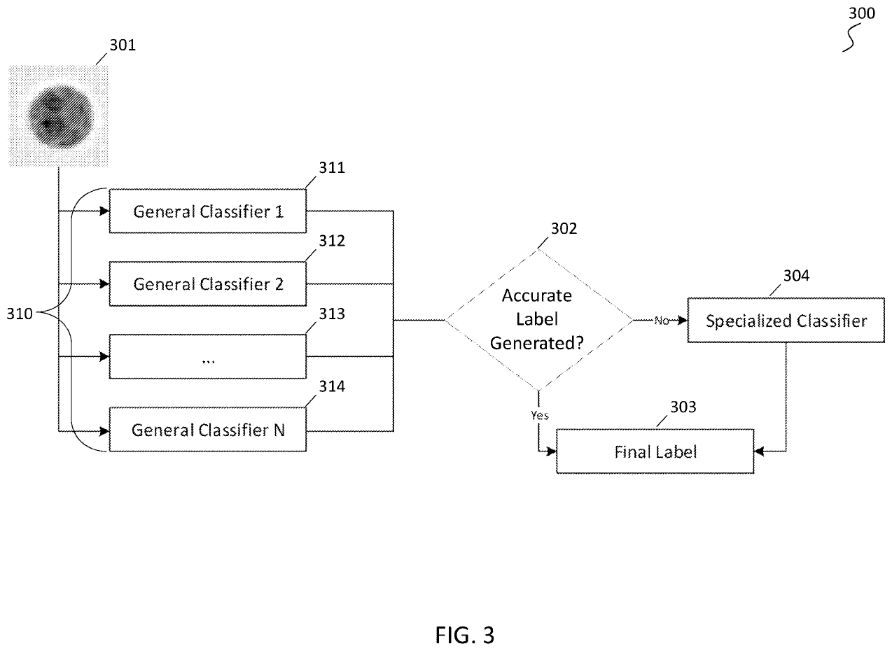

In a system such as shown in FIG. 1 or FIG. 2, a process such as shown in FIG. 3 may be used to classify cells imaged by a camera such as the high optical resolution imaging device 24 of FIG. 1, or the image sensor 210 of FIG. 2. Initially, in the process of FIG. 3, images/representations 301 of a plurality of cells would be received. This may comprise, for example, a processor receiving one or more images which each include representations of a plurality of cells (e.g., as may be captured in a slide-based system such as shown in FIG. 2). Alternatively, receiving representations of a plurality of cells 301 may comprise a processor receiving a plurality of images, each of which comprises a representation of only a single cell (e.g., as may be captured by a flow cell-based flow imaging system such as shown in FIG. 1). Note, the term representation is meant to communicate an analytical portrayal of a cell—for instance, an image, a frequency domain, pixel analysis associated with a cell image, numerical data associated with analysis of a portrayal (e.g., image) of a cell. An image is a subset of a representation, in other words an image is a type of representation.

These representations may then be isolated (e.g., using a cell isolation algorithm, such as an algorithm which thresholds an image captured by a flow cell-based system to identify portions of the image which do and do not represent a cell), and various imaging parameters may be determined for each of the represented cells. This may be done for example, by applying an image analysis algorithm which would process the representations of the cells to identify values for various parameters which were relevant to their classification. Examples of types of algorithms which may be applied to this include those described in U.S. Pat. No. 4,538,299, issued Aug. 27, 1985 for a Method and Apparatus for Locating the Boundary of an Object, the disclosure of which is hereby incorporated by reference in its entirety. However, in some embodiments there may be many types of cells to be classified, including some cells that are quite difficult to discriminate due to their biological and morphological nature. In some cases, to address this, multiple classifiers may be utilized. Additionally, multiple classifiers may be used to heighten certainty in any final label provided and reduce the risk of mislabeling a cell.

An example of how multiple classifiers may be used in some cases is provided in FIG. 3. As shown in that figure, a classification system 300 may include a plurality of general classifiers 310 (e.g., 311, 312, 313, 314). The general classifiers may be configured to receive the cell representations 301 and generate a classification label. However, as noted herein, there are usually multiple cell types that need to be classified for a flow-image analyzer. For example, in some embodiments, the system may need to classify cells into eleven (11) different cell types, such as, for example, Neutrophil, Immature Granulocyte, Lymphocyte, Monocyte, Eosinophil, Basophil, Nucleated Red Blood Cells (NRBCs), Blast, Other-WBC, Non-WBC, and Unidentified. In some cases, the general classifiers 310 may each be trained to identify all of the targeted cell types, such as each of the cell types listed above. It should be understood that although the general classifiers are generally discussed herein as using artificial intelligence (e.g., Convolutional Neural Networks (CNNs)), that other classification methods may be utilized, such as a population-based (PB) classifier which utilizes image generated data and corresponding cluster-based population segmenting to identify cell types, disclosed U.S. Provisional patent application 63/434,658, filed Dec. 22, 2022 which application is hereby incorporated by reference in its entirety. In some examples, a classifier (e.g., a CNN) may utilize artificial intelligence or machine learning concepts to analyze an image of a cell and classify the cell type by providing the associated label. In some examples, a classifier (e.g., a PB classifier) may utilize a population distribution whereby imaging features are parameters for organizing a population distribution of a plurality of cell types, wherein types of cells arc demarcated from this distribution—for instance, by looking for clusters of data and assigning a similar label to the cells within the particular cluster. Put another way, certain classifiers such as PB classifiers may utilize pixel analysis and rules thresholding associated with pixel analysis (e.g., generating masks to analyze pixels of a cell according to various pixel-analysis parameters), creating a distribution, and assigning cell types based on clustering analysis-rather than deep learning or machine learning techniques.

In an example where cell classification is performed using CNNs, the cell classifier may be organized into layers as follows:
1^{st} layer: input layer that takes 128×128×3 ROB image
2^{nd} layer: convolutional layer (filter size=5, stride=(2,2), number of filters=64, and ReLU activation)+batch normalization layer. The output is 64×64×64 tensor.
3^{rd} layer: convolutional layer (filter size=5, stride=(2,2), number of filters=128, and ReLU activation)+batch normalization layer. The output is 32×32×128 tensor.
4^{th} layer: convolutional layer (filter size=5, stride=(2,2), number of filters=256, and ReLU activation)+batch normalization layer. The output is 16×16×256 tensor.
5^{th} layer: convolutional layer (filter size=5, stride=(2,2), number of filters=512, and ReLU activation)+batch normalization layer. The output is 8×8×512 tensor.
6^{th} layer: convolutional layer (filter size=5, stride=(2,2), number of filters=512, and ReLU activation)+batch normalization layer. The output is 4×4×512 tensor.
7^{th} layer: flatten layer
8^{th} layer: fully connected layer with 100 outputs
9^{th} layer: fully connected layer with 11 outputs

It should be understood that the above nine layer model is just one example of how CNNs could be used in a classification system (e.g., to provide functionality of a general classifier). Thus, additional or alternative embodiments may exist in which a CNN-based classifier may also have a different structure than the above or have the same structure but is trained with different data. For example, in some embodiments, the input image size may be defined as N×N×3, where N varies from 10 to 1000. In further embodiments, the filters may vary in size (e.g., the filters used in the 2^{nd} through 6^{th} layer) from 3 to 9. Further additional embodiments may exist in which the number of convolutional layers can vary greatly (e.g., from 3 and 100).

Returning to FIG. 3, a cell representation 301 may be received and analyzed by each of the general classifiers 311, 312, 313, 314, etc. By way of non-limiting example, “General Classifier 1” 311 will analyze the cell representation 301 independently based on its own training, whereas “General Classifier 2” 312, and any subsequent.′General Classifier N″ 314, will also analyze the cell representation 301 independently based on their own training (e.g., based on the training data set used to create those classifiers). In some embodiments, and as represented by the “ . . . ” 313, the number of General Classifiers may vary depending on the needs of the system. Thus, it should be understood that any number of General Classifiers may be utilized.

Once the general classifiers 310 receive and analyze the cell representation 301 (e.g., cell image), the system 300 may evaluate the classification of each of the General Classifiers 310 to determine 302 if an accurate cell label was generated. In some embodiments, the evaluation 302 of the generated cell label may involve identifying a “majority vote” between all of the General Classifiers 310. By way of non-limiting example, in an embodiment where.’ General Classifier 1″ 311 categorizes the cell representation 301 as a Neutrophil, “General Classifier 2” 312 categorizes the cell representation as a Monocyte, and “General Classifier 3” (not shown) and “General Classifier 4” (not shown) categorize the cell representation as a Neutrophil, the system may then determine that because 3 out of the 4 (i.e., 75%) of the General Classifiers determined the cell representation was a Neutrophil, that the cell is likely a Neutrophil. Continuing the non-limiting example, once the system determines 302 that an accurate label was generated, it may apply the final label 303 to the cell representation 301, which in this example would be Neutrophil. In various examples, majority voting can require at least a 50% threshold or above a 50% threshold (the number of classifiers used, as an odd or even number, can affect the thresholding, by way of example).

It should be understood that the above non-limiting example is for illustrative purposes only, and that various other methods of evaluating the label accuracy 302 may exist. For example, in some embodiments, the system may require a 100% unanimous agreement from all the General Classifiers 310 in order to determine that the label is accurate. In a further embodiment, the system 300 could require that a specific percentage (e.g., 60%, 66%, 75%, etc.) of the General Classifiers 310 are in agreement on the cell type. Other embodiments may exist wherein different cell types require different threshold percentages to be assigned. For example, in some embodiments, determining the cell representation 301 is a NRBC may require 60% agreement between the General Classifiers 310, whereas determining that the cell representation is a Monocyte may require 75% agreement between the General Classifiers. In other words, certain cell types (e.g., a first cell type) may require a larger agreement percentage among the classifiers than other cell types (e.g., a second cell type, different than the first cell type)—for instance, rarer cell types, or harder to classify cell types.

In addition to cell type, the outputs of the General Classifiers 310 may also be weighted based on the type of classification system being used. For example, if General Classifier 1 311 was using a population-based classification system and General Classifier 2 312 was using a CNN based classification system, General Classifier 2 may have a greater weight (e.g., a greater impact) during the evaluation of the label accuracy 302. For instance, rather than a simple vote where each vote is equal, the votes would be weighted (e.g., General Classifier 2 would have a weighting of 1.1 vs a weighting of 1.0 for General Classifier 1). Different cell types could have different weightings for each classifier, for instance in circumstances where General Classifier 1 is better at identifying certain cell types and thus weighted more for certain cell types (e.g., red blood cell types) and General Classifier 2 is better at identifying certain cell types and thus weighted more for those other celtain cell types (e.g., white blood cells). It is also possible that a classifier's outputs may be weighted based on other information, such as its accuracy, precision and/or recall in making particular types of cell classifications.

Alternatively, if it is determined 302 that an accurate label was not generated, the system 300 may invoke an appropriate Specialized Classifier 304 (e.g., a specialized classifier trained to distinguish between only the cell types provided hy the general classifiers with the highest confidence). In some embodiments, the Specialized Classifier 304 may be an image classifier that is trained to evaluate a small number (e.g., two) of cell types. This contrasts with the General Classifiers 310, which are trained to identify all required cell types, including, but not limited to Neutrophil, Immature Granulocyte, Lymphocyte, Monocyte, Eosinophil, Basophil, Nucleated Red Blood Cells (NRBCs), Blast, Other-WBC, Non-WBC, and Unidentified. The specialized classifier may be any suitable type of classifier, such as a CNN based classifier or a population based classifier.

Thus, because the Specialized Classifiers 304 are only trained to identify a few (e.g., two) cell types, they are more accurate and reliable when making a determination. Therefore, because there are multiple cell types of interest, a specific/unique Specialized Classifier 304 may be trained for each pair of cell types. Thus, by way of non-limiting example, a plurality of Specialized Classifiers 304 may be utilized, in which each Specialized Classifier is trained for a unique, or custom, determination between a pair of cells, such as, for example, determining if cell representation 301 shows:
1. Neutrophil vs Immature Granulocyte
2. Neutrophil vs Lymphocyte
3. Neutrophil vs Monocyte
4. Neutrophil vs Eosinophil
5. Neutrophil vs Basophil
6. Neutrophil vs NRBC
7. Neutrophil vs Blast
8. Neutrophil vs etc.
9. Immature Granulocyte vs Lymphocyte
10. Immature Granulocyte vs Monocyte
11. Or any other combination of cell types.

Thus, in a case where the General Classifiers 310 disagree on the cell type, and the system 300 may determine 302 that the generated label is inaccurate and thus a Specialized Classifier 304 may be required to make a final determination (e.g., identify a consolidation label). For example, if 50% of the General Classifiers 310 classified the cell representation 301 as a Lymphocyte, while the other 50% of General Classifiers classified the cell representation as a Monocyte, the system 300 may utilize a Specialized Classifier 304 that was trained to specifically distinguish between Lymphocytes and Monocytes to make the final determination between the two cell types. Once the Specialized Classifier 304 completes the determination, the system may apply the final label 303.

In one example embodiment, the system 300 may include two General Classifiers 310 (e.g., 311 and 312), in which each General Classifier generates a classification label for a given input image (e.g., cell representation 301). If the classification labels from the two General Classifiers agree, then the system may determine 302 that the labels are accurate and apply the final classification label 303. Alternatively, if the two General Classifier classification labels disagree (e.g., Lymphocyte vs Monocyte), then the Specialized Classifier 304 that is trained to evaluate those two cell types (e.g., Lymphocyte and Monocyte) is invoked to generate the final label 303.

In a further example embodiment, the system 300 may include three General Classifiers 310, in which each General Classifier generates a classification label as well as a confidence score (e.g., a value representative of the likelihood that classification label is accurate) for a given input image, and this confidence score may be used in classification. For example, in some cases, if a general classifier has a particularly high confidence in a particular label (e.g., 98% confidence that a cell is a Lymphocyte), then that label may be treated as the final label without considering a Specialized Classifier, even if another General Classifier may provide a different label. This may also be done only in certain cases. For instance, if a General Classifier is identified as a preferred classifier for a particular type of cell (e.g., particularly accurate in identifying that cell type) then if that General Classifier identified a representation as that cell type with greater than a threshold confidence, then the representation could be classified as that type of cell without consulting a Specialized Classifier, even if another General Classifier may disagree. Note, the high confidence score which provides a final label without considering a Specialized Classifier is exemplary and different scores can be used for different cell types (e.g., at least a 98% score for lymphocytes results in a lymphocyte classification being used without consideration of a Specialized Classifier, whereas a 95% score for neutrophils results in a neutrophil classification being used without consideration of a specialized classifier). Please note, the confidence scores are exemplary and any range of scores can be used to trigger this automatic final classification, for instance 90%-100%.

Confidence scores may be applied in other ways as well. For example, if two or three of the General Classifier's classification labels agree, then, in some embodiments (e.g., where the threshold is 65% majority), the agreed General Classifier classification label will be the final label 303. However, if all three General Classifier classification labels are different, then the two classification labels with highest confidence scores may be provided to the Specialized Classifier 304 to generate the final label. By way of non-limiting example, assume that the labels and confidence scores of the three General Classifiers are (Lymphocyte, 0.80), (Monocyte, 0.65), and (NRBC, 0.71). Accordingly, because the three General Classifier classification labels do not match, the Specialized Classifier 304 that is configured to carry out a binary classification between Lymphocyte and NRBC may be invoked to generate the final label because they have the highest confidence scores of 0.8 and 0.71 respectively.

In a further illustrative embodiment, the system (e.g., 300) may include more classifiers and/or more complicated operations. Specifically, in some embodiments, the system may include a Population Based (PB) General Classifier, a first Convolutional Neural Network (CNN) General Classifier (CNN1), a second CNN General Classifier (CNN2), and a plurality of Specialized Classifiers. In some embodiments, the PB General Classifier may evaluate the cell representation (e.g., FIG. 3 at 301) to determine a cell label (e.g., PB_Label) and General Classifier CNN1 may evaluate the same cell representation to determine a cell label (e.g., CNN1_label).

As discussed herein, General Classifiers (e.g., 310) may assign a confidence score to any determined classification (e.g., label). Thus, in some embodiments, the system may evaluate and/or determine a confidence level of CNN 1_Label, which is then compared to a particular threshold. If CNN1_Label has a confidence level that that is found to be insufficient (e.g., it does not meet the threshold) the system may immediately assign the UNIDENTIFIED label. However, if the confidence level of CNN 1_Label does meet or exceed the threshold, the determined cell labels (e.g., PB_Label and CNN1_Label) are then compared to determine if they match.

If a match is determined between PB_Label and CNN1_Label, the system may then assign CNN1_Label, which based on the match is also the PB_Label. In a further embodiment, the system may again evaluate the confidence level of CNN1 to determine if it meets or exceeds a predetermined threshold (e.g., 0.6, 0.7, 0.8, etc.). If the system determines that CNN1_Label meets or exceeds the threshold, CNN1_Label would be assigned to the cell representation. Alternatively, if the system were to determine that CNN1_Label is below the threshold, then CNN1_Label cannot be assigned and the system may assign an “UNIDENTIFIED” Label.

Alternatively, in this type of system it may be determined that PB_Label and CNN1_Label do not match. In this case, the system may evaluate if the confidence level of CNN1 meets or exceeds a predetermined threshold (e.g., 0.6, 0.7, 0.8, etc.). If the system determines that CNN1_Label meets or exceeds the threshold, CNN1_Label may then be compared to CNN2_Label (e.g., the cell label determined by General Classifier CNN2) to determine if they match. If CNN 1 Label and CNN2_Label match (e.g., create a unanimous majority), the system may then assign CNN1_Label, which based on the match is also the CNN2_Label, to the cell representation. In another embodiment, the system may determine that CNN 1_Label is below the threshold and thus cannot be assigned. If an identified label does not meet or exceed the threshold, the system may assign an “UNIDENTIFIED” Label.

Scenarios may also exist in which a Specialized Classifier is required for generating a final label in this type of system. As discussed herein, Specialized Classifiers may be used to identify a specific cell type based on the existing classifications created by the General Classifiers (e.g., 310). Thus, in some cases (e.g., when: (1) PB_Label and CNN1_Label do not match and the confidence score of CNN1_Label is below the threshold OR (2) PB_Label and CNN1_Label do not match and the confidence score of CNN1_Label is above the threshold OR (3), CNN 1_Label and CNN2_Label do not match, or other scenarios where the specialized classifiers cannot generate either a cell type or unidentified label) a Specialized Classifier may be utilized to determine which label (e.g., PB_Label, CNN1_Label, CNN2_Label, etc.) is accurate and assigns it as SC_Label. The SC_Label may then be evaluated to determine if it has a confidence score above a given threshold. If the SC_Label meets or exceeds the threshold the cell representation is assigned SC_Label, but if the confidence score is below the threshold, the system may assign the “UNIDENTIFIED” Label.

A further illustration of how multiple types of systems can be combined to provide cell classifications is shown in the logic maps of tables 1 and 2. In some examples, each classifier is of a similar general type (e.g., each a CNN). In some examples, at least some of the classifiers are of a different general type (e.g., Classifier 1 is a PB, Classifier 2 is a CNN, and Classifier 3 is a CNN). In the examples of the tables below, Classifier 2 would be a general primary classifier (configured to generally classify a variety of cells and whose labels hold higher weight), Classifier 1 is a general secondary classifier (configured to generally classify a variety of cells but whose labels hold lesser weight than Classifier 2), Classifier 3 is a particularized classifier (configured to only classify one particular cell type), and the specialized classifier, as described above, is configured to choose from among two different labels provided by two different classifiers so as to choose from among those two different labels.

In the tables below the first particular cell type and second particular cell types can be particular types of cells that are difficult to classify where there may need to be a specialized rule used. For instance, the labeling of a first particular cell type can be one specific cell which is hard to categorize and which would necessitate a second threshold different than a first threshold. The labelling of a second particular cell type can be one specific cell which is hard to categorize and which would necessitate the confirmation of a third classifier (Classifier 3) which is uniquely/solely configured to only analyze that second particular cell type.

```
TABLE 1
Does Classifier 2 provide a label below a particular threshold?
  If yes, then final label is unidentified
  If no, then do Classifier 2 and Classifier 1 agree on the label?
    If yes, then is Classifier 2 labelling a particular first cell type
    (e.g., NRBC) and is this below a particular threshold?
      If yes, then final label is unidentified
      If no, then final label is label assigned by Classifier 2
    If no, then is Classifier 2 labelling a particular second cell
    type (e.g., Blast) and is this above a particular threshold?
        If yes, then do Classifier 2 and Classifier 3 agree?
          If yes, then final label is the label assigned by Classifier 2
          If no, then use a specialized classifier (e.g., a classifier for
          distinguishing the two most confident labels out of those
          provided by classifiers 1, 2 and 3)
            Is the specialized classifier providing a label above a
            threshold?
              If yes, then final label is assigned by specialized classifier
              If no, then final label is unidentified
        If no, then use a specialized classifier (e.g., a classifier for
        distinguishing the two most confident labels out of those
        provided by classifiers 1, 2 and 3)
          Is the specialized classifier providing a label above a
          threshold?
            If yes, then final label is assigned by specialized classifier
            If no, then final label is unidentified
```

```
TABLE 2
Does Classifier 2 provide a label below a particular threshold?
  If yes, then final label is unidentified
  If no, then does Classifier 2 provide an identification of a particular
  first cell type, and is this above a particular threshold?
    If yes, then final label is label assigned by Classifier 2
    If no, do Classifier 2 and Classifier 1 provide the same label?
      If yes, then final label is the label assigned by Classifier 2.
      If no, then is the label assigned by Classifier 3 (e.g., a specialized
      classifier trained to distinguish between the cell types provided
      by classifiers 1 and 2) above a threshold?
      If yes, then final label is Isbel assigned by Classifier 3.
      If no, does Classifier 2 label as a particular second cell type, is this
      above a particular threshold and does Classifier 3 agree with the
      particular second cell type label?
        If yes, then final label is the label assigned by Classifier 3.
        If no, then final label is undefined.
```

It should be understood that, in some cases, any thresholds may be updated or modified (e.g., automatically or manually) based on a number of factors, such as, for example, a change in user preference, a change in the evaluation requirements, change in the imaging system, based on an AI or Machine Learning algorithm, or the like. It should also be understood that the thresholds may be equal across the system (e.g., 0.7 confidence score required for each threshold test discussed above, or alternatively, the thresholds may be customized for each step in the process (e.g., the threshold for CNN1_Label in the first decision may be lower than the threshold in a subsequent decision step).

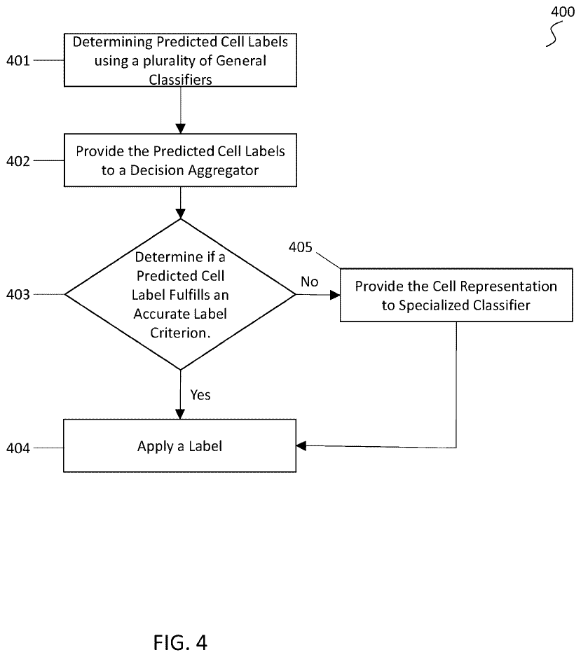

Referring now to FIG. 4, an illustrative method flow diagram 400 is shown in accordance with various embodiments disclosed herein. In some embodiments, and as shown, the method 400 may begin by determining a plurality of predicted cell labels using a plurality of General Classifiers (e.g., 310) 401. The predicted cell labels arc then provided to a decision aggregator 402 that is configured to evaluate the predicted cell labels and determine 403 if one of them fulfills an accurate label criterion (e.g., a label represent at least a threshold level of agreement, or a label is provided with a sufficiently high confidence, etc.).

Responsive to determining that one of the plurality of predicted label fulfils the accurate label criterion, the method 400 may assign the final cell label 404 as the label which satisfied the accurate label criterion. Alternatively, in some embodiments, responsive to determining that none of the plurality of classifiers fulfilled the accurate label criterion, the method 400 may continue with providing the cell representation being labeled to a specialized classifier 405 which had been trained to classify cells into two or more categories from the predicted cell labels.

As discussed herein, various metrics may be used, selected, or modified (e.g., automatically or manually) to determine a compatibility criterion (e.g., a thresholds). Accordingly, in some embodiments, the one or more compatibility criteria may be derived from or based on a majority consensus among the plurality of classifiers of the predicted cell label and/or a unanimous consensus among the plurality of classifiers of the predicted cell label. In additional embodiments, the one or more compatibility criteria may be derived from or based on one of the plurality of classifiers meeting or exceeding a confidence score threshold.

As a further illustration of potential implementations and applications of the disclosed technology, the following examples are provided of non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A computer-implemented method of blood cell classification, comprising: a. obtaining an image of a blood cell; b. identifying, using a plurality of classifiers and the image of the blood cell, a plurality of predicted cell labels for the blood cell, wherein each predicted cell label of the plurality of predicted cell labels is obtained by using a respective classifier of the plurality of classifiers; and c. assigning a consolidated cell label for the blood cell by using a decision aggregator and one or more of the predicted cell labels of the plurality of predicted cell labels.

### Example 2

The computer implemented method of example 1, wherein the decision aggregator is further configured to: a. determine whether one of the predicted cell labels provided by the plurality of classifiers fulfill an accurate label criterion; b. responsive to determining that one of the predicted cell labels fulfills the accurate label criterion, assign the consolidated cell label based on the cell label that fulfills the accurate label criterion; and c. responsive to determining that none of the predicted cell labels fulfill the accurate label criterion, provide the image of the blood cell to a specialized classifier configured to assign the consolidated cell label.

### Example 3

The computer implemented method of example 2, wherein the accurate label criterion is selected from the group consisting of: a. a majority consensus among the plurality of classifiers of the predicted cell label, and b. a unanimous consensus among the plurality of classifiers of the predicted cell label.

### Example 4

The computer implemented method of example 2, wherein the accurate label criterion is selected from a group consisting of: a. one of the plurality of classifiers' predicted cell label meeting a confidence score threshold, and b. one of the plurality of classifiers' predicted cell label exceeding a confidence score threshold.

### Example 5

The computer implemented method of any of examples 2-4, wherein the specialized classifier is one of a plurality of specialized classifiers, each of the plurality of specialized classifier configured to classify cell images into one of two classes.

### Example 6

The computer implemented method of any of examples 2-5, wherein each of the plurality of classifiers provides a confidence score associated with the predicted cell label that classifier provides, and the processor is configured to select the specialized classifier based on two predicted cell labels having a two highest confidence scores.

### Example 7

The computer implemented method of any of examples 2-6, wherein the specialized classifier comprises a convolutional neural network.

### Example 8

The computer implemented method of any of examples 1-7, wherein one of the plurality of classifiers comprises a convolutional neural network.

### Example 9

The computer implemented method of any of examples 1-8, wherein, for each image from the set of images, each of the plurality of classifiers is configured to provide its predicted cell label utilizing image analysis of the blood cell depicted in that image.

### Example 10

The computer implemented method of any of examples 1-9, wherein obtaining the image of the blood cell comprises: a. flowing a blood sample through a flowcell; and b. capturing the image of the blood cell using a camera as the blood cell is flowing through a viewing area of the flowcell.

### Example 11

A computer-implemented blood cell classification system, comprising: a. a processor; b. a non-transitory computer readable medium storing instructions that cause the processor to perform a set of acts comprising: i. receiving a set of images, each image from the set of images depicting a blood cell; and ii. for each image from the set of images: A. determining, using a plurality of classifiers, a set of predicted cell labels for the blood cell depicted in that image, wherein each of the plurality of classifiers provides a respective predicted cell label of the blood cell depicted in that image; and B. Providing the set of predicted cell labels to a decision aggregator configured to assign a consolidated cell label.

### Example 12

The computer-implemented cell classification system of example 11, wherein the decision aggregator is further configured to: a. determine whether one of the predicted cell labels from the set of predicted cell labels fulfils an accurate label criterion; b. responsive to determining that one of the predicted cell labels fulfils the accurate label criterion, assign the consolidated cell label based on the predicted cell label which fulfills the accuracy criterion; and c. responsive to determining that none of the predicted cell labels fulfill the accurate label criterion, provide the cell labels to a specialized classifier configured to assign the consolidated cell label.

### Example 13

The computer-implemented cell classification system of example 12, wherein the accurate label criterion is selected from the group consisting of: a. a majority consensus among the plurality of classifiers of the predicted cell label; and b. a unanimous consensus among the plurality of classifiers of the predicted cell label.

### Example 14

The computer-implemented cell classification system of example 12, wherein the accurate label criterion is selected from the group consisting of: a. one of the plurality of classifiers' predicted cell label meeting a confidence score threshold; and b. one of the plurality of classifiers' predicted cell label exceeding a confidence score threshold.

### Example 15

The computer-implemented cell classification system of any of examples 12-14, wherein the specialized classifier is one of a plurality of specialized classifiers, each of the plurality of specialized classifier configured to classify cell images into one of a set of two potential cell classes . . .

### Example 16

The computer-implemented cell classification system of any of examples 12-15, wherein each of the plurality of classifiers provides a confidence score associated with the predicted cell label that classifier provides, and the processor is configured to select the specialized classifier based on two predicted cell labels having a two highest confidence scores.

### Example 17

The computer-implemented cell classification system of any of examples 12-16, wherein the specialized classifier comprises a convolutional neural network.

### Example 18

The computer-implemented cell classification system of any of examples 11-17, wherein one of the plurality of classifiers comprises a convolutional neural network.

### Example 19

The computer-implemented cell classification system of any of examples 11-18, wherein, for each image from the set of images, each of the plurality of classifiers is configured to provide its predicted cell label utilizing image analysis of the blood cell depicted in that image.

### Example 20

The computer-implemented cell classification system of any of examples 11-19, wherein: a. the system comprises: i. a camera; and ii. a 11owcell having a viewing zone; and b. the instructions stored on the non-transitory computer readable medium comprise instructions which, when executed, cause the processor to capture the set of images by imaging a blood sample as it flows through the viewing zone of the flowcell.

### Example 21

A computer-implemented training method for blood cell classification: a. receiving a plurality of images of blood cells; b. using the plurality of images of blood cells to train a plurality of general classifiers, wherein each classifier from the plurality of general classifiers is trained to classify cell images into a set of classes corresponding to that general classifier; and c. using the plurality of blood cell images to train a plurality of specialized classifiers, wherein each classifier from the plurality of specialized classifiers is trained to classify cell images into a set of classes corresponding to that specialized classifiers; wherein: A. the plurality of general classifiers comprises a general classifier whose corresponding set of classes has a minimum general cardinality, wherein the minimum general cardinality is not greater than any other cardinality of a set of classes corresponding to any classifier from the set of general classifiers; B. the plurality of specialized classifiers comprises a specialized classifier whose corresponding set of classes has a maximum specialized cardinality, wherein the maximum specialized cardinality is not less than any other cardinality of a set of classes corresponding to any classifier from the set of specialized classifiers; and C. the minimum general cardinality is greater than the maximum specialized cardinality.

### Example 22

The computer-implemented training method of example 21, wherein at least one of the set of general classifiers comprises a convolutional neural network.

### Example 23

The computer implemented training method of any of examples 21-22, wherein each of the plurality of specialized classifiers is configured to provide corresponding confidence values when providing a label for a cell image.

### Example 24

The computer implemented training method of any of examples 21-23, wherein the maximum specialized cardinality is 2.

### Example 25

The computer implemented training method of any of examples 21-25, wherein the minimum general cardinality is 11.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to pelfonn the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the claims should not be treated as limited to the examples, drawings, embodiments and illustrations provided above, but instead should be understood as having the scope provided when their terms are given their broadest reasonable interpretation as provided by a general-purpose dictionary, except that when a term or phrase is indicated as having a particular meaning under the heading Explicit Definitions, it should be understood as having that meaning when used in the claims.

### Explicit Definitions

It should be understood that, in the above examples and the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, in the above examples and claims, the term “set” should be understood as one or more things which are grouped together.

1. A computer-implemented method of blood cell classification, comprising:
a. obtaining an image of a blood cell;
b. identifying, using a plurality of classifiers and the image of the blood cell, a plurality of predicted cell labels for the blood cell, wherein each predicted cell label of the plurality of predicted cell labels is obtained by using a respective classifier of the plurality of classifiers; and
c. assigning a consolidated cell label for the blood cell by using a decision aggregator and one or more of the predicted cell labels of the plurality of predicted cell labels.

2. The computer implemented method of claim 1, wherein the decision aggregator is further configured to:
a. determine whether one of the predicted cell labels provided by the plurality of classifiers fulfill an accurate label criterion;
b responsive to determining that one of the predicted cell labels fulfills the accurate label criterion, assign the consolidated cell label based on the cell label that fulfills the accurate label criterion; and
c. responsive to determining that none of the predicted cell labels fulfill the accurate label criterion, provide the image of the blood cell to a specialized classifier configured to assign the consolidated cell label.

3. The computer implemented method of claim 2, wherein the accurate label criterion is selected from the group consisting of:
a. a majority consensus among the plurality of classifiers of the predicted cell label; and
b a unanimous consensus among the plurality of classifiers of the predicted cell label.

4. The computer implemented method of claim 2, wherein the accurate label criterion is selected from a group consisting of:
a. one of the plurality of classifiers' predicted cell label meeting a confidence score threshold, and
b. one of the plurality of classifiers' predicted cell label exceeding the confidence score threshold.

5. The computer implemented method of claim 2, wherein the specialized classifier is one of a plurality of specialized classifiers, each of the plurality of specialized classifier configured to classify cell images into one of two classes.

6. The computer implemented method of claim 2, wherein each of the plurality of classifiers provides a confidence score associated with the predicted cell label that classifier provides, and the processor is configured to select the specialized classifier based on two predicted cell labels having a two highest confidence scores.

7. The computer implemented method of claim 2, wherein the specialized classifier comprises a convolutional neural network.

8. The computer implemented method of claim 1, wherein one of the plurality of classifiers comprises a convolutional neural network.

9. The computer implemented method of claim 1, wherein, for each image from a set of images, each of the plurality of classifiers is configured to provide its predicted cell label utilizing image analysis of the blood cell depicted in that image.

10. The computer implemented method of claim 1, wherein obtaining the image of the blood cell comprises:
a. flowing a blood sample through a flowcell; and
b. capturing the image of the blood cell using a camera as the blood cell is flowing through a viewing area of the flowcell.

11. A computer-implemented blood cell classification system, comprising:
a. a processor;
b. a non-transitory computer readable medium storing instructions that cause the processor to perform a set of acts comprising:
i. receiving a set of images, each image from the set of images depicting a blood cell; and
ii. for each image from the set of images:
A. determining, using a plurality of classifiers, a set of predicted cell labels for the blood cell depicted in that image, wherein each of the plurality of classifiers provides a respective predicted cell label of the blood cell depicted in that image; and
B. providing the set of predicted cell labels to a decision aggregator configured to assign a consolidated cell label.

12. The computer-implemented cell classification system of claim 11, wherein the decision aggregator is further configured to:
a. determine whether one of the predicted cell labels from the set of predicted cell labels fulfils an accurate label criterion;
b responsive to determining that one of the predicted cell labels fulfils the accurate label criterion, assign the consolidated cell label based on the predicted cell label which fulfills the accuracy criterion; and
c. responsive to determining that none of the predicted cell labels fulfill the accurate label criterion, provide the cell labels to a specialized classifier configured to assign the consolidated cell label.

13. The computer-implemented cell classification system of claim 12, wherein the accurate label criterion is selected from the group consisting of:
a. a majority consensus among the plurality of classifiers of the predicted cell label; and
b. a unanimous consensus among the plurality of classifiers of the predicted cell label.

14. The computer-implemented cell classification system of claim 12, wherein the accurate label criterion is selected from the group consisting of:
a. one of the plurality of classifiers' predicted cell label meeting a confidence score threshold; and
b one of the plurality of classifiers' predicted cell label exceeding a confidence score threshold.

15. The computer-implemented cell classification system of claim 12, wherein the specialized classifier is one of a plurality of specialized classifiers, each of the plurality of specialized classifier configured to classify cell images into one of a set of two potential cell classes.

16. The computer-implemented cell classification system of claim 12, wherein each of the plurality of classifiers provides a confidence score associated with the predicted cell label that classifier provides, and the processor is configured to select the specialized classifier based on two predicted cell labels having a two highest confidence scores.

17. The computer-implemented cell classification system of claim 12, wherein the specialized classifier comprises a convolutional neural network.

18. The computer-implemented cell classification system of claim 11, wherein one of the plurality of classifiers comprises a convolutional neural network.

19. The computer-implemented cell classification system of claim 11, wherein, for each image from the set of images, each of the plurality of classifiers is configured to provide its predicted cell label utilizing image analysis of the blood cell depicted in that image.

20. The computer-implemented cell classification system of claim 11, wherein:
a. the system comprises:
i. a camera; and
ii. a flowcell having a viewing zone;
and
b. the instructions stored on the non-transitory computer readable medium comprise instructions which, when executed, cause the processor to capture the set of images by imaging a blood sample as it flows through the viewing zone of the flowcell.

21-25. (canceled)
